(19) United States
(12) Patent Application Publication
(10) Pub. No.: US 2011/0274990 A1
(43) Pub. Date: Nov. 10, 2011

(54) Methanol and Hydrogen Peroxide Fuel Cell with Hydroxyl Ion Exchange Membrane

(76) Inventor: YANG G XU, (US)

(21) Appl. No.: 12/834,552

(22) Filed: Jul. 12, 2010

Related U.S. Application Data
(60) Provisional application No. 61/332,248, filed on May 7, 2010.

(51) Int. Cl. H01M 8/06; H01M 8/10

(52) U.S. Cl. 429/408; 429/492

(57) ABSTRACT

The fuel cell uses hydrogen peroxide (as oxidant) and methanol (as fuel) to generate electric power and it can operate in a low temperature (20-90° C.). Hydrogen peroxide is used in cathode (coated with catalyst) compartment located at one side of a hydroxyl ion exchange membrane. At the other side of the membrane, methanol is used in anode (coated with catalyst) compartment. A catalytic reduction reaction occurs at cathode to produce hydroxyl ions from hydrogen peroxide, and a catalytic oxidation reaction occurs at anode to produce water and carbon dioxide from methanol. When hydroxyl ions move through electrolyte in the ion exchange membrane from cathode to anode, an electric current is generated accordingly.

### CROSS-REFERENCE TO RELATED APPLICATIONS

The present application claims the benefit of U.S. Provisional Patent Application No. 61/332,248 filed May 7, 2010. U.S. Provisional Patent Application No. 61/332,248 filed May 7, 2010 is hereby incorporated by reference in its entirety.

### FIELD OF THE INVENTION

The present invention relates to a fuel cell. More specifically, it relates to a direct hydrogen peroxide fuel cell utilizing methanol as fuel, which generates electric current by catalytic reduction of liquid hydrogen peroxide at cathode side coupled with catalytic oxidation of liquid methanol which results in hydroxyl transfer across an ion exchange membrane (with electrolyte).

### BACKGROUND OF THE INVENTION

The existing problem with hydrogen/hydrogen-peroxide (H/H₂O₂) is that the energy density is still lower than desired for many applications—particularly as a power supplier for mobile devices. In a H/H₂O₂ fuel cell, hydrogen peroxide H₂O₂ is used indirectly to generate oxygen gas for utilization at the cathode. There are significant difficulties from doing so, because the mass density achievable in this gas phase is ordinarily a thousand times less than that available in a liquid phase, the area current density is at least 100 times less from this limiting factor alone. To address this issue, ordinary fuel cells typically use a compressor to pressurize the air/O₂ to a few Bars. Even so, the current density is still at least 30 times less than the liquid phase counterpart.

As disclosed in prior U.S. Pat. No. 6,554,877, fuel cells using methanol as a liquid fuel and hydrogen peroxide as oxidant, with a cathode made using screen-printing methods of 20% platinum on activated carbon on waterproof paper, have been used. However, as noted therein, catalyst poisoning or cathode sintering is encountered. Prior U.S. Pat. No. 7,344,799 also disclosed that, in acidic methanol/hydrogen peroxide fuel cell operation, oxidation of anode catalyst and adsorption of dehydro-methanol derivatives on catalyst affected the reduction reactions of methanol and thus resulted in the fuel cell efficiency's decrease. In addition, selection of the cathode material is also difficult, as only certain cathode materials will effectively reduce H₂O₂ at a desirable rate, i.e., at a rate of reduction which will produce sufficient current, but without undue H₂O₂ decomposition. Utilization of noble metal catalysts (palladium and platinum) in this manner facilitates hydrogen peroxide decomposition, releasing oxygen as waste, and thus a decrease in cell efficiency.

In view of these deficiencies of conventional direct hydrogen peroxide and methanol fuel cells, the present invention will provide a direct hydrogen peroxide fuel cell operating in an alkaline environment and having an electrocatalyst not susceptible to catalyst poisoning or sintering, or side reactions with the oxidant. The direct hydrogen peroxide fuel cell in the present invention will be capable of generating stable electric power over time, i.e., which does not experience degradation over time. The fuel cell can be manufactured in a compact design because it runs on liquid fuel and liquid oxidant.

### BRIEF DESCRIPTION OF THE DRAWINGS

The ideas and objects of the present invention can be more clearly described by the accompanying drawings, wherein:

FIG. 1 shows a schematic diagram of an exemplary fuel cell of the present invention.

FIG. 2 shows a schematic diagram of exemplary fuel cell of the present invention and its auxiliary equipments recycling the methanol and hydrogen peroxide.

FIG. 3 shows a schematic diagram of exemplary anode and cathode structure of fuel cell in the present invention.

### SUMMARY OF THE INVENTION

The present invention is a direct methanol/hydrogen-peroxide fuel cell comprising an electrical load, an anode with a catalyst in an anode compartment, a cathode with a catalyst in a cathode compartment, a hydroxyl ion exchange membrane, a liquid methanol source, and a liquid hydrogen-peroxide source. The fuel cell generates electrical energy by the acts of electrochemically reacting methanol in an anode compartment, and electrochemically reacting hydrogen peroxide in a cathode compartment. The anode includes a platinum-ruthenium-palladium catalyst. The cathode includes an iron (Fe), palladium, platinum and titanium catalyst and is processed with Fe²⁺ or Ti³⁺ solution. The catalysts are particles in supported layer configuration on a carbon fiber sheet backing The cathode includes an ion conductor and a catalyst layer comprising the catalyst, and a hydrophilic wetting agent, and wherein the anode includes an ion conductor and a catalyst layer comprising the catalyst, and a hydrophilic wetting agent. The wetting agent is a compound having perfluorocarbon moieties, and the ion conductor is a carbon fiber sheet backing. The hydroxyl ion exchange membrane is constructed from a quaternary ammonium base type of poly phthalazinone ether ketone and processed by potassium hydroxide (KOH) solution method. Accordingly, the fuel cell operates in an alkaline electrolyte environment. It overcomes the difficulties that oxidation of anode's platinum catalyst and adsorption of dehydro-Methanol derivatives on the catalyst occur in those fuel cell operations of acidic electrolyte. The fuel cell further comprises a reservoir connected to its cathode compartment for holding and supplying the hydrogen peroxide to the cathode compartment and a pump for recycling the hydrogen peroxide between the reservoir and the cathode compartment. The reservoir includes a condenser for conserving water removed from the reservoir by using a hydrogen peroxide selective membrane, to maintain an electrochemically sufficient concentration of hydrogen peroxide. The fuel cell further comprising a reservoir connected to its anode compartment for holding and supplying the methanol to the anode compartment and a pump for recycling the unreacted methanol between the reservoir and the anode compartment. The methanol is in a concentration of about 0.5 to 3.0 molar. The hydrogen peroxide is in a concentration of about 5-30% volume/volume.

### DETAILED DESCRIPTION OF THE INVENTION

The embodiments of the present invention are described as following. As shown in FIG. 1, liquid methanol (CH₃OH) is fed to an anode compartment 12 in the fuel cell 10. The anode 14 is electrically connected with a load 11 that consumes electrical power. Liquid hydrogen peroxide (H₂O₂) is fed to a cathode compartment 13 in the fuel cell. The cathode 15 is also connected with the electrical load 11. The anode 14 and cathode 15 are in contact with and separated by a hydroxyl ion electrolyte membrane 16.

In the fuel cell, hydrogen peroxide is reduced producing hydroxyl ions at the cathode 15:

3H₂O₂+6e⁻→6OH⁻

and methanol is oxidized at the anode 14:

CH₃OH-6e⁻+6OH⁻→CO₂+5H₂O

The hydroxyl ions generated at the cathode 15 permeate through the membrane 16 to the anode 14 which react with the hydrogen peroxide and produce carbon dioxide and water. The total reaction is:

CH₃OH+3H₂O₂═CO₂+5H₂O

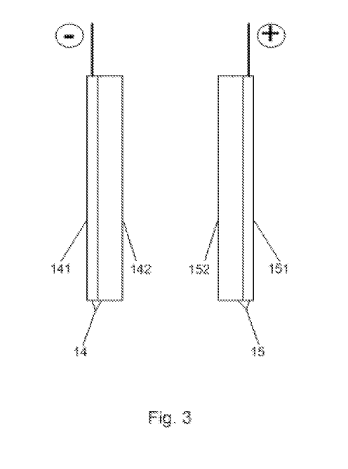

The anode 14 is formed of porous conductive substrate 141 (FIG. 3) with platinum-ruthenium-palladium fine alloy particles as electrocatalyst. The fine particles may be loaded onto a carbon fiber backing paper 142 in the range of about 0.5-4.0 mg/cm² (0.5-5 nm diameter) by liquid phase deposition method. However, electro-oxidation is more efficient at higher loading levels. The preferred platinum comprises 10-90 atom percent of the alloy. The alloy particles may be unsupported (i.e., dispersed on high surface area carbon) or supported. The high surface area carbon may be Vulcan XC-72A available from Cabot, Inc, USA. A carbon fiber sheet backing may be used to make electrical contact with the fine alloy electrocatalyst.

The cathode 15 is formed of porous conductive substrate 151 and constructed to be hydrophilic in nature so that the hydrogen peroxide wets the entire catalyst layer. The electrocatalyst and backing layers 152 (FIG. 3) are primarily made of hydrophilic materials. The catalyst layer includes Fe²⁺ or Ti³⁺. In the presence of Fe²⁺ or Ti³⁺, the decomposition of hydrogen peroxide may take the path with free radicals such as HO⁻ (hydroxyl) and HOO being formed. The catalyst layer also includes a catalyst, a hydroxyl solubility-inducing material. The catalyst is alloys of iron (Fe), palladium, platinum and titanium or combinations thereof. The catalyst layer is supported or unsupported on a backing layer in a similar manner discussed herein respecting the anode. The catalyst layer may also include a hydrophilic wetting agent to improve wetting of the layer.

The fuel cell includes a hydroxyl ion exchange membrane 16. The membrane 16 is adhered to anode 14 and cathode 15. The membrane 16 is an electrolyte membrane of quaternary ammonium base type of poly phthalazinone ether ketone (QPPEK-OH). It is constructed by taking phthalazinone from poly ether ketone (PPEK) as base material, and then invoking the processing procedures: (1) methylation using chlorine, (2) tape casting in liquid phase, (3) quaternization of trimethylamine and (4) KOH solution processing. The conductivity and methanol permeability of an exemplary membrane is 1.14×10⁻² S/cm and 6.57×10⁻⁷ cm²/s respectively for the polymer base phthalazinone ether ketone film of each duplicate segment with an average 1.3 quaternary ammonium ions.

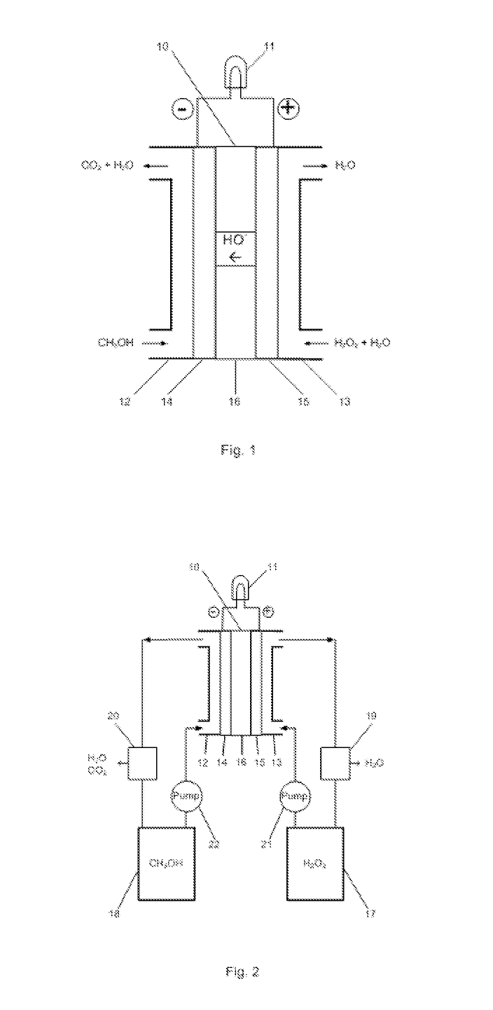

The diagram shown in FIG. 2 illustrates the operation of fuel cell 10. Specifically, hydrogen peroxide and water (as the oxidant) are added to the cathode side of the fuel cell, and methanol is added to the anode side of the fuel cell, to produce electric current by the flow of hydroxyl ion, over the anode/cathode membrane. Methanol and hydrogen peroxide solutions must be added continuously to each of the anode and the cathode sides of the fuel cell, respectively. It is done, on anode side, by a methanol reservoir 18 connected to fuel cell's anode compartment 12 and a pump 22 for recycling the methanol between the reservoir and the anode compartment, and, on cathode side, by a hydrogen peroxide reservoir 17 connected to fuel cell's cathode compartment 13 and a pump 21 for recycling the hydrogen peroxide between the reservoir and the cathode compartment. Importantly, the concentrations of each of the solutions must be within a predetermined range, in order to achieve satisfactory operation of the fuel cell. Therefore, the concentration of the solutions must be monitored and adjusted before injection thereof into the fuel cells. At the anode side, a water and carbon dioxide separation device 20 is employed to concentrate the unreacted methanol. The separation device filters out the carbon dioxide gas and water from the methanol and concentrate the methanol. At the cathode side, a water separation device 19 is employed to concentrate the hydrogen peroxide. The water separation device 19 includes a membrane having a low diffusivity for hydrogen peroxide and a high diffusivity for water. For example, a NAFION membrane will remove water from the aqueous solution of hydrogen peroxide. The preferred concentrations of the fuel component (methanol) are 0.05M to 10M, and the most preferred concentrations are 0.25 to 3M. The hydrogen peroxide concentration is made to be stoichiometric with the fuel concentration. For example, 3M hydrogen peroxide with 1M methanol, or, 0.3M hydrogen peroxide with 0.1M methanol. Preferred concentrations are between +10% and −10% of stoichiometric.

The fuel cell is a viable power source capable of sustaining several tens of watts per square cm. Higher current and power densities can be attained by optimizing the concentration of the methanol and/or hydrogen peroxide. Better electrical performance would also be realized by adjusting the fuel cell operation temperature.

What is claimed is:

1. A direct hydrogen peroxide fuel cell utilizing methanol, comprising: an anode plate in anode compartment, a cathode plate in a cathode compartment, a hydroxyl ion exchange membrane connecting the two compartments and in contact with the anode plate and the cathode plate, a methanol source feeding methanol liquid into anode compartment, and a hydrogen peroxide source feeding hydrogen peroxide liquid into cathode compartment, and an electrical load connected between the anode and the cathode,

2. The fuel cell according to claim 1, wherein the hydroxyl ion exchange membrane is an electrolyte membrane of quaternary ammonium base type of poly phthalazinone ether ketone (QPPEK-OH).

3. The fuel cell according to claim 2, wherein the electrocatalyst is potassium hydroxide (KOH) built in the ion exchange membrane by solution processing methods and thus the fuel cell operates in an alkaline environment.

4. The fuel cell according to claim 1, wherein the anode is comprised of a porous, polymer-impregnated and electrically conductive substrate of carbon fiber sheet backing.

5. The fuel cell according to claim 4, wherein the anode further comprises a conductive binder which is porous, inert, and ion-conductive polymer.

6. The fuel cell according to claim 1, wherein the cathode further comprises a porous and electrically conductive substrate of carbon fiber sheet backing.

7. The fuel cell according to claim 6, wherein the cathode further comprises a conductive binder which is porous, inert, and ion-conductive polymer.

8. The fuel cell according to claim 1, wherein the cathode and anode further comprises catalysts which are particles of metal selected from the group consisting of ruthenium, rhodium, palladium, osmium, iridium and platinum, iron (Fe) and titanium or a mixture thereof, to assist in catalyzing the reduction of hydrogen peroxide or the oxidation of fuel, respectively.

9. The fuel cell according to claims 4 and 6, wherein the substrates of anode and cathode both are further attached to the electrocatalyst in the membrane of claim 2.

10. The fuel cell of claim 1 further comprising a reservoir connected to its cathode compartment for holding and supplying the hydrogen peroxide to the cathode compartment and a pump for recycling the hydrogen peroxide between the reservoir and the cathode compartment.

11. The fuel cell of claim 10 further including a condenser for conserving water removed from the reservoir by using a hydrogen peroxide selective membrane, to maintain an electrochemically sufficient concentration of hydrogen peroxide.

12. The fuel cell of claim 1 further comprising a reservoir connected to its anode compartment for holding and supplying the methanol to the anode compartment and a pump for recycling the methanol between the reservoir and the anode compartment.

15. The fuel cell of claim 1 wherein the methanol is in a concentration of about 0.25 to 3.0 molar.

16. The fuel cell of claim 1 wherein the hydrogen peroxide is in a concentration of about 5-30% volume/volume.
